(19) United States
(12) Patent Application Publication
(10) Pub. No.: US 2013/0248694 A1
(43) Pub. Date: Sep. 26, 2013

(54) LIGHT-RECEIVING-ELEMENT MODULE

(71) Applicant: Nobuo OHATA, Chiyoda-ku (JP)

(72) Inventor: Nobuo OHATA, Chiyoda-ku (JP)

(73) Assignee: Mitsubishi Electric Corporation, Chiyoda-ku (JP)

(21) Appl. No.: 13/609,664

(22) Filed: Sep. 11, 2012

(30) Foreign Application Priority Data
Mar. 23, 2012 (JP) 2012-067948

(51) Int. Cl. G01J 1/04

(52) U.S. Cl. 250/227.11; 250/216

(57) ABSTRACT

A light-receiving-element module is provided which has a greater high-frequency characteristic and light receiving sensitivity than those of conventional technologies. A light-receiving-element module includes a first refractive part that refracts an optical signal with a first wavelength or an optical signal with a second wavelength, and a second refractive part that refracts the optical signal with the first wavelength and the optical signal with the second wavelength refracted by the first refractive part so as to reduce a chromatic aberration. The light-receiving-element module also includes a light receiving element that converts the optical signal with the first wavelength or the optical signal with the second wavelength refracted by the second refractive part into an electric signal by photoelectric conversion.

### CROSS-REFERENCE TO RELATED APPLICATION

This application claims the benefit of Japanese Patent Application No. 2012-67948, filed on Mar. 23, 2012, the entire disclosure of which is incorporated by reference herein.

### FIELD

This application relates generally to a light-receiving-element module.

### BACKGROUND

Unexamined Japanese Patent Application KOKAI Publication No. 2001-223369 discloses a light-receiving-element module that includes an optical fiber which transmits a signal light, a lens which combines the signal light on a waveguide light receiving element, and an amplifier which amplifies an electrical signal output by the light receiving element through photoelectric conversion.

In order to increase the high-frequency characteristic of the waveguide light receiving element disclosed in Unexamined Japanese Patent Application KOKAI Publication No. 2001-223369, it is necessary to reduce a time of the carrier that travels through the light absorbing layer of a photo diode. Hence, it is necessary to make the width of the waveguide narrow, and to increase the refractive index of the lens that combines the light emitted from the optical fiber to the waveguide.

When combining signals emitted from the optical fibers with different wavelengths by a lens having a large refractive index, the chromatic aberration of the lights produced by the lens becomes great, and the positional misalignment of combined points becomes great, resulting in the reduction of the light receiving sensitivity of the light-receiving-element module. This technical issue occurs in the case of typical light receiving elements of a non-waveguide type.

The present invention has been made in view of the above-explained circumstance, and it is an object of the present invention to provide a light-receiving-element module that has greater high-frequency characteristic and light receiving sensitivity than those of conventional technologies.

### SUMMARY

To achieve the object, a light-receiving-element module according to an aspect of the present invention includes: a first refractor that refracts an optical signal with a first wavelength or an optical signal with a second wavelength; a second refractor that further refracts the optical signal with the first wavelength and the optical signal with the second wavelength refracted by the first refractor so as to reduce a chromatic aberration; and a light receiving element that converts the optical signal with the first wavelength or the optical signal with the second wavelength refracted by the second refractor into an electric signal by photoelectric conversion.

According to the present invention, it becomes possible to provide a light-receiving-element module that has a greater high-frequency characteristic and light receiving sensitivity than those of conventional technologies.

### BRIEF DESCRIPTION OF THE DRAWINGS

A more complete understanding of this application can be obtained when the following detailed description is considered in conjunction with the following drawings, in which:

FIG. 1 is a perspective view showing a light-receiving-element module according to an embodiment of the present invention;

FIG. 2 is a cross-sectional view of the light-receiving-element module taken along a line A-A′ in FIG. 1;

FIG. 3 is a cross-sectional view showing a refractive part of a light-receiving-element module according to a second modified example of the embodiment of the preset invention;

FIG. 4 is a cross-sectional view showing a refractive part of a light-receiving-element module according to a fourth modified example of the embodiment of the present invention; and

FIG. 5 is a cross-sectional view showing a light-receiving-element module according to a sixth modified example of the embodiment of the present invention taken along a line A-A′.

### DETAILED DESCRIPTION

### Embodiment

An explanation will be given of a light-receiving-element module 100 according to an embodiment of the present invention with reference to the accompanying drawings.

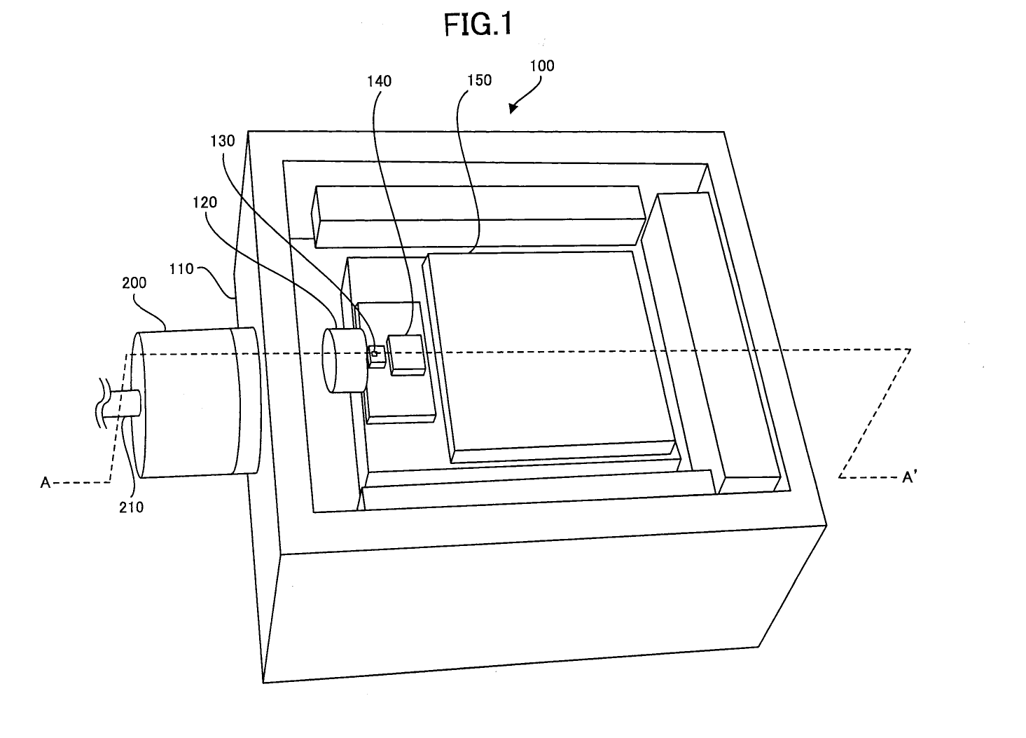

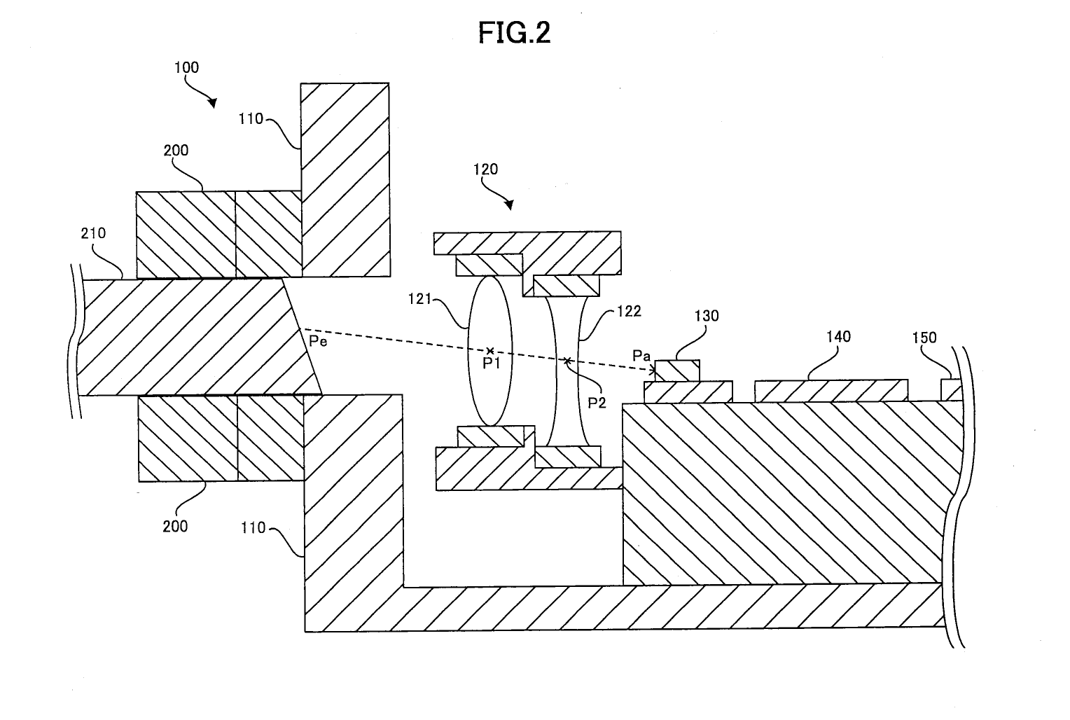

FIG. 1 is a perspective view showing the light-receiving-element module 100, and FIG. 2 is a cross-sectional view of the light-receiving-element module 100 taken along a line A-A′.

The light-receiving-element module 100 has a refractive unit 120 that refracts an optical signal output by an optical fiber 210 of a ferrule 200, and a light receiving element 130 of a waveguide type that performs photoelectric conversion on the optical signal refracted by the refractive unit 120. The refractive unit 120 and the light receiving element 130 are built in a package 110 coupled with the optical fiber 210. Moreover, an amplifier element 140 that amplifies an electric signal output by the light receiving element 130 and an RF (Radio Frequency) substrate 150 that processes the amplified electric signal are also built in the package 110.

The optical fiber 210 transmits an optical signal with a wavelength of 1310 nm (hereinafter, referred to as a first wavelength) and an optical signal with a wavelength of 1550 nm (hereinafter, referred to as a second wavelength) which are defined by the standard specification ITU-T G.693 of the international telecommunication union.

As shown in FIG. 2, the refractive unit 120 includes a first refractive part 121 and a second refractive part 122. The first refractive part 121 is a convex lens having a positive refractive power, and converges the optical signal output by the optical fiber 210. The second refractive part 122 is a concave lens having a negative refractive power, disperses the optical signal converged by the first refractive part 121, and inputs the dispersed optical signal into the light receiving element 130. The first and second refractive parts 121 and 122 reduce the chromatic aberration between the refracted optical signal of the first wavelength and the refracted optical signal of the second wavelength.

The optical fiber 210, the first refractive part 121, the second refractive part 122, and the light receiving element 130 are disposed in such a way that a center point Pe of an end face of the optical fiber 210, a principal point P1 of the first refractive part 121, a principal point P2 of the second refractive part 122, and a center point Pa of a light receiving surface of the light receiving element 130 are aligned over a same substantially straight line. This is in order to increase the light receiving efficiency of the light receiving element 130.

A synthesized refractive power k of the first refractive part 121 and the second refractive part 122 can be expressed as a formula “k=k1+k2−dk1·k2”.

The first refractive part 121 and the second refractive part 122 are disposed at locations distant from each other by a distance d that satisfies the following conditional equations (1) to (3) relating to the synthesized refractive power k, and are configured to have curvatures r1 to r4 that satisfy the conditional equations (1) to (3). Hence, the synthesized refractive power k of the first refractive part 121 and the second refractive part 122 remains the same or is not likely to change throughout when the first wavelength is refracted and when the second wavelength is refracted.

Δk=Δk1+Δk2−d(Δk1·k2+k1·Δk2)≦ε (1)

Δk1=Δn1(r1−r2) (2)

Δk2=Δn2(r3−r4) (3)

where:

k1 is the refractive power of the first refractive part 121;

k2 is the refractive power of the second refractive part 122;

Δk1 is the refractive power of the first refractive part 121 for the optical signal with the first wavelength−the refractive power of the first refractive part 121 for the optical signal with the second wavelength different from the first wavelength;

Δk2 is the refractive power of the second refractive part 122 for the optical signal with the first wavelength−the refractive power of the second refractive part 122 for the optical signal with the second wavelength;

d is a distance between the first refractive part 121 and the second refractive part 122;

r1 is a curvature of the first refractive part 121 at the optical-fiber side;

r2 is a curvature of the first refractive part 121 at the second-refractive-part-122 side;

r3 is a curvature of the second refractive part 122 at the first-refractive-part-121 side;

r4 is a curvature of the second refractive part 122 at the light-receiving-element-130 side;

Δn1 is the refractive index of the first refractive part 121 for the optical signal with the first wavelength−the refractive index of the first refractive part 121 for the optical signal with the second wavelength;

Δn2 is the refractive index of the second refractive part 122 for the optical signal with the first wavelength−the refractive index of the second refractive part 122 for the optical signal with the second wavelength; and

ε is a predetermined constant.

The appropriate range of ε can be defined by those skilled in the art through a laboratory test, and the most appropriate value of ε is “0”.

According to such a configuration, since the first and second refractive parts 121 and 122 satisfy the conditional equation (1), there is no difference between the synthesized refractive power for the optical signal with the first wavelength and the synthesized refractive power for the optical signal with the second wavelength, or such a difference is insignificant. Hence, there is no chromatic aberration between the optical signal with the first wavelength and the optical signal with the second wavelength, or such chromatic aberration hardly occurs. Accordingly, even if the synthesized refractive power k of the first refractive part 121 and the second refractive part 122 is increased in order to improve the high-frequency characteristic, the light receiving sensitivity of the light receiving element does not decrease or hardly decreases.

According to this embodiment, the explanation was given of an example case in which the optical signals transmitted by the optical fiber 210 are the optical signal with the wavelength of 1310 nm (i.e., the first wavelength) and the optical signal with the wavelength of 1550 nm (i.e., the second wavelength), but the wavelength of the optical signal transmitted by the optical fiber 210 is not limited to those wavelengths. Moreover, according to this embodiment, although the light receiving element 130 is a waveguide type, the present invention is not limited to such a type, and for example, a facial light receiving element can be used.

### First Modified Example of Embodiment

According to the above-explained embodiment, the explanation was given of the case in which the first refractive part 121 is a convex lens with a positive refractive power and the second refractive part 122 is a concave lens with a negative refractive power. However, the present invention is not limited to this configuration, and the first refractive part 121 may be a concave lens with a negative refractive power and the second refractive part 122 may be a convex lens with a positive refractive power.

### Second Modified Example of Embodiment

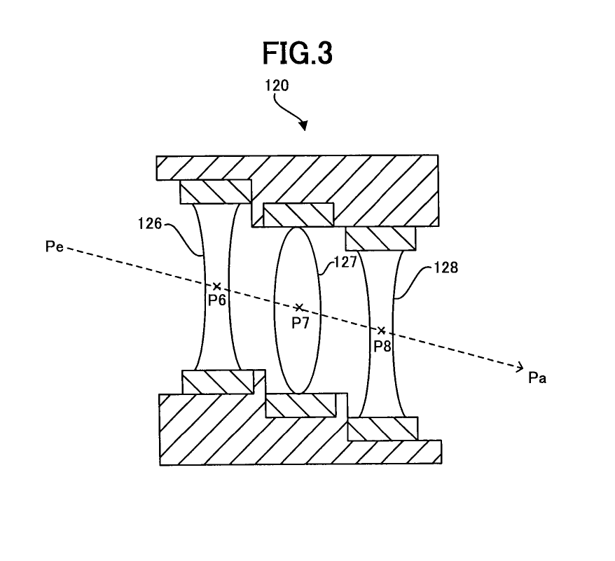

According to the above-explained embodiment, the refractive unit 120 includes the two lenses that are the first refractive part 121 and the second refractive part 122. According to a second modified example, however, as shown in FIG. 3, the refractive unit 120 includes three lenses that are a first refractive part 126, a second refractive part 127, and a third refractive part 128.

The first refractive part 126 is a concave lens with a negative refractive power, and disperses the optical signal emitted from the optical fiber 210. The second refractive part 127 is a convex lens with a positive refractive power, and converges the optical signal dispersed by the first refractive part 126. The third refractive part 128 is a concave lens with a negative refractive power, disperses the optical signal converged by the second refractive part 127, and inputs the dispersed optical signal into the light receiving element 130.

The optical fiber 210, the first to third refractive parts 126 to 128, and the light receiving element 130 are disposed in such a way that the center point Pe of an end face of the optical fiber 210, principal points P6 to P8 of the first to third refractive parts 126 to 128, and the center point Pa of the light receiving surface of the light receiving element 130 are aligned over a same substantially straight line.

The first refractive part 126 and the second refractive part 127 are disposed at locations distant from each other by a distance d that satisfies the above-explained conditional equations (1) to (3), and are configured to have curvatures r1 to r4 that satisfy the conditional equations (1) to (3).

Moreover, a synthesized refractive power k′ of the second refractive part 127 and the third refractive part 128 can be expressed as a formula “k′=k2+k3−d′k2·k3”.

The second refractive part 127 and the third refractive part 128 are disposed at locations distant from each other by a distance d′ that satisfies the following conditional equations (4) to (6), and are configured to have curvatures r3 to r6 that satisfy the conditional equations (4) to (6). Hence, the synthesized refractive power k′ of the second refractive part 127 and the third refractive part 128 remains same or is not likely to change throughout when the first wavelength is refracted and when the second wavelength is refracted.

Δk′=Δk2+Δk3−d′(Δk2·k3+k2·Δk3)≦ε′ (4)

Δk2=Δn2(r3−r4) (5)

Δk3=Δn3(r5−r6) (6)

Where:

k2 is the refractive power of the second refractive part 127;

k3 is the refractive power of the third refractive part 128;

Δk2 is the refractive power of the second refractive part 127 for the optical signal with the first wavelength−the refractive power of the second refractive part 127 for the optical signal with the second wavelength;

Δk3 is the refractive power of the third refractive part 128 for the optical signal with the first wavelength−the refractive power of the third refractive part 128 for the optical signal with the second wavelength;

d′ is the distance between the second refractive part 127 and the third refractive part 128;

r3 is a curvature of the second refractive part 127 at the first-refractive-part-126 side;

r4 is a curvature of the second refractive part 127 at the third-refractive-part-128 side;

r5 is a curvature of the third refractive part 128 at the second-refractive-part-127 side;

r6 is a curvature of the third refractive part 128 at the light-receiving-element-130 side;

Δn2 is the refractive index of the second refractive part 127 for the optical signal with the first wavelength−the refractive index of the second refractive part 127 for the optical signal with the second wavelength;

Δn3 is the refractive index of the third refractive part 128 for the optical signal with the first wavelength−the refractive index of the third refractive part 128 for the optical signal with the second wavelength; and

ε′ is a predetermined constant.

The appropriate range of ε′ can be defined by those skilled in the art through a laboratory test, and the most appropriate value of ε′ is “0”.

According to such a configuration, the synthesized refractive power of the first refractive part 126 and the second refractive part 127 remains the same or is not likely to change between the first wavelength and the second wavelength. Moreover, the synthesized refractive power of the second refractive part 127 and the third refractive part 128 remains the same or is not likely to change between the first wavelength and the second wavelength. Hence, the total synthesized refractive power of the first refractive part 126, the second refractive part 127, and the third refractive part 128 remains the same or is not likely to change between the first wavelength and the second wavelength.

### Third Modified Example of Embodiment

According to the second modified example of the embodiment, the explanation was given of the case in which the refractive unit 120 includes the first, second and third refractive parts 126, 127, and 128, and the synthesized refractive power of the first refractive part 126, the second refractive part 127, and the third refractive part 128 remains the same or is not likely to change between the first wavelength and the second wavelength. However, the refractive unit 120 may be n number of refractive parts, adjoining refractive parts may be disposed at locations distant from each other by a distance that satisfies the above-explained conditional equations (1) to (3), and such refractive parts may have curvatures that satisfy the conditional equations (1) to (3). According to such a configuration, the synthesized refractive power of the n number of refractive parts remains the same or is not likely to change between the first wavelength and the second wavelength.

### Fourth Modified Example of Embodiment

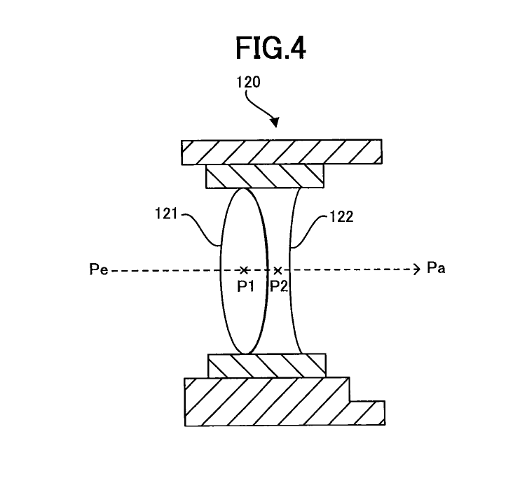

According to the above-explained embodiment, the explanation was given of the case in which the refractive unit 120 includes the two lenses that are the first refractive part 121 and the second refractive part 122. However, as shown in FIG. 4, a tablet having the two lenses that are the first refractive part 121 and the second refractive part 122 put together may be used as the refractive unit 120.

According to this configuration, since the refractive unit 120 is a tablet having the two lenses put together, the light-receiving-element module can be downsized in comparison with the case in which the refractive unit 120 is configured by the two lenses.

### Fifth Modified Example of Embodiment

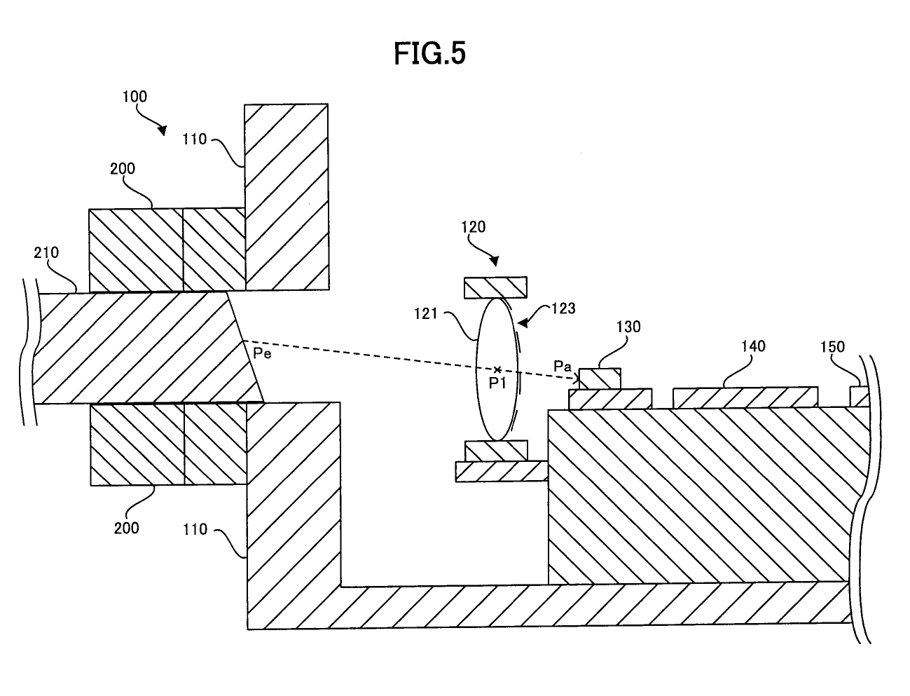

According to the above-explained embodiment, the refractive unit 120 includes the two lenses that are the first refractive part 121 and the second refractive part 122. However, as shown in FIG. 5, the refractive unit 120 may include the first refractive part 121 that is a convex lens with a positive refractive power, and a second refractive part 123 which is formed on a surface of the first refractive part 121 at the light-receiving-element-130 side and which is a diffraction grating with a negative refractive power.

The first and second refractive parts 121 and 123 are configured so as to satisfy the above-explained conditional equation (1). Hence, the synthesized refractive power k of the first refractive part 121 and the second refractive part 123 remains the same or is not likely to change throughout when the first wavelength is refracted and when the second wavelength is refracted.

Hence, according to such a configuration, the refractive unit 120 is configured by a lens and a diffractive grating formed on the surface thereof, and thus the light-receiving-element module can be downsized in comparison with the cases in which the refractive unit 120 is configured by the two lenses and the refractive unit 120 is configured by a tablet having the two lenses put together.

### Sixth Modified Example of Embodiment

According to the fifth modified example of the embodiment, the explanation was given of the case in which the refractive unit 120 includes the first refractive part 121 that is a convex lens with a positive refractive power, and the second refractive part 123 that is a diffraction grating formed on the surface of the first refractive part 121 at the light-receiving-element-130 side and having a negative refractive power.

However, the present invention is not limited to such a configuration, and the refractive unit 120 may include the first refractive part 121 that is a convex lens with a positive refractive power and the second refractive part 123 that is a diffraction grating formed on a surface of the first refractive part 121 at the optical-fiber-210 side and having a negative refractive power.

### Seventh Modified Example of Embodiment

Moreover, the refractive unit 120 may include the first refractive part 121 that is a concave lens with a negative refractive power, and the second refractive part 123 that is a diffraction grating formed on a surface of the first refractive part 121 and having a positive refractive power. The second refractive part 123 may be formed on a surface of the first refractive part 121 at the light-receiving-element-130 side or on a surface of the first refractive part 121 at the optical-fiber-210 side.

Having described and illustrated the principles of this application by reference to one or more preferred embodiments, it should be apparent that the preferred embodiments may be modified in arrangement and detail without departing from the principles disclosed herein and that it is intended that the application be construed as including all such modifications and variations insofar as they come within the spirit and scope of the subject matter disclosed herein.

The present invention is appropriate for an optical module used for, for example, an optical communication.

What is claimed is:

1. A light-receiving-element module comprising:
a first refractor that refracts an optical signal with a first wavelength or an optical signal with a second wavelength;
a second refractor that further refracts the optical signal with the first wavelength and the optical signal with the second wavelength refracted by the first refractor so as to reduce a chromatic aberration; and
a light receiving element that converts the optical signal with the first wavelength or the optical signal with the second wavelength refracted by the second refractor into an electric signal by photoelectric conversion.

2. The light-receiving-element module according to claim 1, wherein the first refractor and the second refractor are integrated together.

3. The light-receiving-element module according to claim 1, wherein the light receiving element employs a waveguide configuration.

4. The light-receiving-element module according to claim 3, wherein the first refractor and the second refractor are each a lens.

5. The light-receiving-element module according to claim 3, wherein
either one of the first and second refractors is a lens, and
the other one of the first and second refractors is a diffraction grating.

6. The light-receiving-element module according to claim 2, wherein the light receiving element employs a waveguide configuration.

7. The light-receiving-element module according to claim 6, wherein the first refractor and the second refractor are each a lens.

8. The light-receiving-element module according to claim 6, wherein
either one of the first and second refractors is a lens, and
the other one of the first and second refractors is a diffraction grating.
